(19) United States
(12) Patent Application Publication
(10) Pub. No.: US 2025/0233877 A1
(43) Pub. Date: Jul. 17, 2025

(54) METHOD FOR DETECTING ABNORMAL BEHAVIOR IN ENCRYPTED NETWORK TRAFFIC USING BERT LANGUAGE MODEL AND APPARATUS FOR THE SAME

(71) Applicant: ELECTRONICS AND TELECOMMUNICATIONS RESEARCH INSTITUTE, Daejeon (KR)

(72) Inventors: Jae-Hak Yu, Daejeon (KR); Dae-Sung Moon, Daejeon (KR); Ki-Jong Koo, Daejeon (KR); Yang-Seo Choi, Daejeon (KR)

(73) Assignee: ELECTRONICS AND TELECOMMUNICATIONS RESEARCH INSTITUTE, Daejeon (KR)

(21) Appl. No.: 18/919,663

(22) Filed: Oct. 18, 2024

(30) Foreign Application Priority Data
Jan. 11, 2024 (KR) 10-2024-0004562

(51) Int. Cl. H04L 9/40; H04L 41/16

(52) U.S. Cl. CPC H04L 63/1425; H04L 41/16; H04L 63/145

(57) ABSTRACT

Disclosed herein are a method for detecting anormal behavior in encrypted network traffic using a BERT language model and an apparatus for the same. The method for detecting anormal behavior in encrypted network traffic, the method being performed by an anormal behavior detection apparatus, the method including collecting encrypted network traffic from a network, generating training data in which header information for each packet is preprocessed in a format of a sequence, based on the encrypted network traffic, training a network traffic classification model based on a Bidirectional Encoder Representations from Transformers (BERT) language model using the training data, and classifying anormal behavior traffic in encrypted network traffic based on the trained network traffic classification model.

### CROSS REFERENCE TO RELATED APPLICATION

This application claims the benefit of Korean Patent Application No. 10-2024-0004562, filed Jan. 11, 2024, which is hereby incorporated by reference in its entirety into this application.

### BACKGROUND OF THE INVENTION

### 1. Technical Field

The present disclosure relates generally to technology for detecting abnormal behavior in encrypted network traffic using a Bidirectional Encoder Representations from Transformers (BERT) language model, and more particularly to technology that classifies or detects anormal (malicious) behavior or malware for each type based on packet information in network traffic and encrypted traffic by utilizing a BERT model included in AI technology.

### 2. Description of the Related Art

Traffic encryption in networks is encryption protocol technology that has significantly advanced over the past few decades due to an increase in concerns about the privacy (personal information) and confidentiality of users or enterprises between web browsers and web servers and in Internet applications and websites. Recently, traffic using encryption protocols such as Secure Sockets Layer (SSL) or Transport Layer Security (TLS) has many advantages in that the safety, security, and anonymity of services can be ensured. As of 2020, anormal behavior and malware (malicious software code) execution targeting encrypted traffic have exceeded 60%, and the distribution of malware, command issuance, control operations, etc. via Hypertext transfer protocol secure (HTTPS), are rapidly increasing. Further, malicious traffic and cyber-attacks which are made by cyber criminals to bypass a monitoring system or a firewall through encryption technology which intensifies personal information, such as a Virtual Private Network (VPN) or The Onion Routing (Tor), are continuously increasing.

Such network traffic encryption has a dual nature of the advantage of ensuring the security and anonymity of users or services and the disadvantage of making it extremely difficult to identify and classify malicious traffic, data leakage, and anormal activities that may threaten the users. Further, currently, with rapid development of network traffic encryption technology, it is difficult to accurately detect or identify anormal activities in a service types of application and encrypted traffic for respective types and then establish response strategies.

Recently, efforts have been actively made in academia and industry to develop and commercialize technologies that can rapidly detect and respond to anormal behavior and malware based on network traffic and encrypted network traffic.

### PRIOR ART DOCUMENTS

### Patent Documents

(Patent Document 1) Korean Patent Registration No. 10-2537023, Date of Registration: May 23, 2023 (Title: Method for Controlling Network Traffic Based Traffic Analysis Using Artificial Intelligence (AI) and Apparatus for Performing the Method)

### SUMMARY OF THE INVENTION

Accordingly, the present disclosure has been made keeping in mind the above problems occurring in the prior art, and an object of the present disclosure is to classify network traffic or encrypted network traffic for respective types and detect anormal behavior based on Bidirectional Encoder Representations from Transformers (BERT) represented by a language model among AI technologies.

Another object of the present disclosure is to improve the accuracy of detection of anormal behavior and malware in encrypted traffic by performing pre-training and fine-tuning on a classification model through a pattern in which unique information of a packet header for each protocol is represented and embedded without loss.

In accordance with an aspect of the present disclosure to accomplish the above objects, there is provided a method for detecting anormal behavior in encrypted network traffic, the method being performed by an anormal behavior detection apparatus, the method including collecting encrypted network traffic from a network; generating training data in which header information for each packet is preprocessed in a format of a sequence, based on the encrypted network traffic; training a network traffic classification model based on a Bidirectional Encoder Representations from Transformers (BERT) language model using the training data; and classifying anormal behavior traffic in encrypted network traffic based on the trained network traffic classification model.

The training data may correspond to a packet header information sequence in which normal traffic and anormal behavior traffic are labeled.

The packet header information sequence may be generated to correspond to a maximum size represented by single field information of a packet header for each protocol, and is generated such that respective pieces of configuration information are separated from each other in the packet header.

A portion that is not filled with data in the packet header information sequence may be padded with an arbitrary value (Ex. zero-padding or null values).

The network traffic classification model may correspond to a form in which an anormal behavior detection neural network layer for detecting anormal behavior in the encrypted network traffic is added to a pre-trained BERT language model.

Training the network traffic classification model may include performing Masked Language Model (MLM) training on the network traffic classification model using the packet header information sequence; and performing Next Sentence Prediction (NSP) training on the network traffic classification model using the packet header information sequence.

Training the network traffic classification model may include adding a new malware detection neural network layer for detecting new malware that is previously unknown to the network traffic classification model, and training the new malware detection neural network layer using the packet header information sequence.

Training the new malware detection neural network layer may include tokenizing the packet header information sequence based on an instruction code used for pre-training of the BERT language model, and training the network traffic classification model to detect new malware that is previously unknown by inputting a tokenized packet header information sequence to the network traffic classification model.

The instruction code may include instruction codes capable of indexing values of all header information appearing in the training data, and includes instruction codes related to special tokens for exception handling in token indexing when header information of each packet is recognized as an individual token.

The instruction codes related to the special tokens may correspond to a code indicating a space, a code signifying an individual token, a code representing token indexing not found in a dictionary, a code indicating start of a sequence, a code indicating separation between two sequences, and a code indicating a padding token.

The training data may be generated by utilizing header information of a single packet or pieces of header information of multiple packets.

In accordance with another aspect of the present disclosure to accomplish the above objects, there is provided an anormal behavior detection apparatus, including a processor configured to collect encrypted network traffic from a network, generate training data in which header information for each packet is preprocessed in a format of a sequence, based on the encrypted network traffic, train a network traffic classification model based on a BERT language model using the training data, and classify anormal behavior traffic in encrypted network traffic based on the trained network traffic classification model; and memory configured to store the network traffic classification model.

The training data may correspond to a packet header information sequence in which normal traffic and anormal behavior traffic are labeled.

The packet header information sequence may be generated to correspond to a maximum size represented by single field information of a packet header for each protocol, and is generated such that respective pieces of configuration information are separated from each other in the packet header.

A portion that is not filled with data in the packet header information sequence may be padded with an arbitrary value (Ex. zero-padding or null values).

The network traffic classification model may correspond to a form in which an anormal behavior detection neural network layer for detecting anormal behavior in the encrypted network traffic is added to a pre-trained BERT language model.

The processor may be configured to perform Masked Language Model (MLM) training on the network traffic classification model using the packet header information sequence, and perform Next Sentence Prediction (NSP) training on the network traffic classification model using the packet header information sequence.

The processor may be configured to add a new malware detection neural network layer for detecting new malware that is previously unknown to the network traffic classification model, and train the new malware detection neural network layer using the packet header information sequence.

The processor may be configured to tokenize the packet header information sequence based on an instruction code used for pre-training of the BERT language model, and train the network traffic classification model to detect new malware that is previously unknown by inputting a tokenized packet header information sequence to the network traffic classification model.

The instruction code may include instruction codes capable of indexing values of all header information appearing in the training data, and includes instruction codes related to special tokens for exception handling in token indexing when header information of each packet is recognized as an individual token.

The instruction codes related to the special tokens may correspond to a code indicating a space, a code signifying an individual token, a code representing token indexing not found in a dictionary, a code indicating start of a sequence, a code indicating separation between two sequences, and a code indicating a padding token.

The training data may be generated by utilizing header information of a single packet or pieces of header information of multiple packets.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is an operation flowchart illustrating a method for detecting anormal behavior in encrypted network traffic using a BERT language model according to an embodiment of the present disclosure;

FIG. 2 is a diagram illustrating examples of respective modules constituting an apparatus for detecting anormal behavior according to the present disclosure;

FIG. 3 is a diagram illustrating an example of a PCAP file generated from a packet captured from a network;

FIG. 4 is a diagram illustrating an example of a value obtained by extracting a packet header, extracted from the PCAP file illustrated in FIG. 3, in units of 2 bytes;

FIG. 5 is a diagram illustrating an example of a process of generating training data through a procedure of parsing for each piece of configuration information within a TCP header and 4 byte padding according to the present disclosure;

FIG. 6 is a diagram illustrating an example of a single packet header information-based input sequence according to an example of the present disclosure;

FIG. 7 is a diagram illustrating an example of a multi-packet header information-based input sequence in the same flow according to the present disclosure;

FIG. 8 is a diagram illustrating an example of a pre-training process in BERT for detecting anormal behavior in encrypted traffic according to the present disclosure;

FIG. 9 is a diagram illustrating an example of a task-wise fine-tuning module-based unknown malware detection process or a purpose-wise encrypted traffic classification process using BERT according to the present disclosure; and

FIG. 10 is a diagram illustrating an apparatus for detecting anormal behavior in encrypted network traffic using a BERT language model according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Existing methods for classifying encrypted traffic or detecting anormal behavior in the encrypted traffic based on AI technology may be broadly classified into four categories.

A first category is a detection method based on 5-tuples including port information.

A Transmission Control Protocol/Internet Protocol (TCP/IP) packet, which is a network transmission/reception unit, is broadly divided into a header and a payload, and a port-based encrypted traffic classification method classifies encrypted traffic using the port information of a transport layer. This methodology may be a method that is not influenced by encryption protocols and that has efficient processing cost and high accuracy. However, recently, with the application of technologies such as port masquerading technology, random port setting policies, and Network Address Translation (NAT) protocols, the performance of such methodology has greatly declined in a current network environment.

A second category is a detection method for generating fingerprints using plaintext.

This is a method for generating fingerprints using plaintext (e.g., certificates) in encrypted traffic and classifying traffic or defined anormal activities. Representative fingerprint generation techniques are Deep Packet Inspection (DPI) and FlowPrint, wherein DPI uses the entire packet content including a header and a payload. That is, when a fixed string pattern predefined in a packet is detected, the packet may be classified (identified) as the corresponding traffic class. FlowPrint is a method for more promptly identifying traffic using unencrypted field information, such as the size, certification, and time properties in a small number of initial packets starting in the flow. However, this method is disadvantageous in that only plaintext information is utilized, and thus it is highly likely to lose original information due to the possibility of forgery/alternation of traffic being transmitted. Further, in a recent network environment, the use of plaintext is decreasing. In particular, in traffic to which encryption technology (e.g., TLS 1.3) is applied, there is a limitation in that it is difficult to perform anormal behavior detection to which a fingerprint generation method is applied.

A third category is a detection method that uses statistical features and a traditional Machine Learning (ML) algorithm model.

This is a method for extracting statistical features from encrypted traffic and for classifying the encrypted traffic and identifying anormal behavior without plaintext through a traditional Machine Learning (ML) algorithm. Such ML algorithms based on statistical features are advantageous in that there is no need to check packet content in bytes, thus decreasing computational complexity. Further, because only the statistical feature values or data are utilized, encrypted traffic may be identified even if packet content is not known. However, these methodologies have limitations in that they are dependent on expert knowledge and the characteristics of algorithms and in that identification accuracy and generalization ability thereof are reduced depending on whether statistical features are selected and traffic is labeled.

A fourth category is a detection method using a deep learning model.

Recently, complicated patterns in raw traffic are automatically trained based on the deep learning model and are applied to anormal behavior classification and identification. Therefore, recently, the deep learning model is actively utilized for classifying or identifying encrypted traffic in various fields including academy and industry. In particular, research into an encrypted traffic classification model that is extended or enhanced based on a CNN that is a convolutional neural network or a RNN that is a recurrent neural network has been conducted. However, these methods are limited in that dependency on the amount and distribution of labeled training data (or learning data) is very high and model biases attributable to network environment change or the like occur, thus making it difficult to guarantee new encryption technology or malware detection performance.

Therefore, the present disclosure intends to propose new detection technology capable of supplementing the limitations of the existing detection methods.

The present disclosure proposes technology for classifying or detecting anormal behavior and malware in encrypted network traffic based on BERT represented by a languages model, among AI models, and providing the results of classification and detection.

To date, inventions related to encrypted traffic classification or anormal behavior detection have extracted and utilized protocol packet header information having a fixed size (e.g., 2 bytes or 4 bytes) as input data for training/learning. Due to this restriction, pieces of different information are represented to be bound to 4 bytes or truncated, and thus a problem has arisen in that unique characteristics or significant properties of information are lost.

Therefore, the present disclosure is intended to perform parsing on each field area or each piece of information of a header for each protocol (e.g., IP and TCP, IP and UDP, or the like), to represent the parsed information by 2 bytes or a maximum of 4 bytes, and to use the represented information as input data (e.g., in units of a token or the like), wherein an area shorter than bytes set by the system is processed with padding (e.g., zero padding). By means of this configuration, there is an advantage in that information represented in each area of a packet header may be maintained without change.

Furthermore, the present disclosure does not greatly depend on a large amount of labeled data, as in the case of the existing CNN or RNN, and may classify or detect network traffic or encrypted network traffic for respective types by combining pieces of header information in a single packet or multiple packets in a flow.

Hereinafter, embodiments of the present disclosure will be described in detail with reference to the attached drawings.

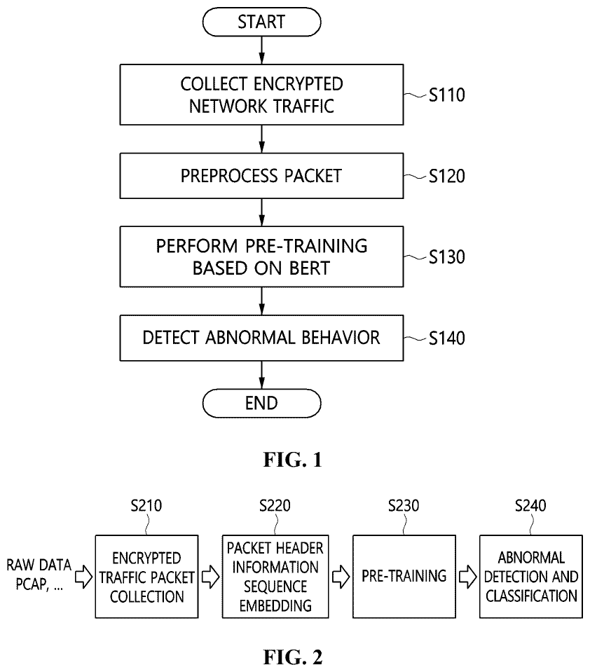

FIG. 1 is an operation flowchart illustrating a method for detecting anormal behavior in encrypted network traffic using a BERT language model according to an embodiment of the present disclosure.

Referring to FIG. 1, in the method for detecting anormal behavior in encrypted network traffic using a BERT language model according to the embodiment of the present disclosure, an anormal behavior detection apparatus collects encrypted network traffic from a network at step S110.

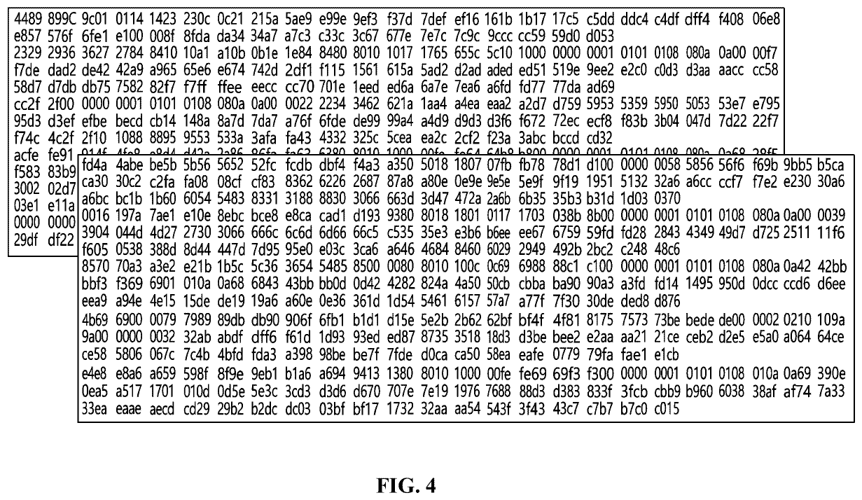

For example, as shown in FIG. 3, a packet traveling over a network environment may be captured using a tool such as tcpdump, and may then be collected in the form of a Packet Capture (PCAP) file. Referring to FIG. 3, the PCAP file is composed of various types of information such as the addresses and port numbers of a transmitting side and a receiving side, protocols, the total length of each packet, the number of packets transferred between the transmitting and receiving sides, and time, and thus these pieces of information may be collected through each packet.

The pieces of information collected in this way may be represented by hexadecimal values, as shown in FIG. 4.

That is, various types of information such as the addresses and port numbers of the transmitting side and the receiving side, protocols, packet length, the number of packets received from the transmitting and receiving sides for a specific time, that is, T seconds, the number of times HTTP communication is executed, a window size, time information, etc., which correspond to the pieces of header information in IP and TCP protocols, in the PCAP file collected in FIG. 3, may be represented by hexadecimal values.

Also, in the method for detecting anormal behavior in encrypted network traffic using a BERT language model according to the embodiment of the present disclosure, the anormal behavior detection apparatus generates training data in which header information for each packet is preprocessed in the format of a sequence, based on the encrypted network traffic at step S120.

Here, the training data may correspond to a packet header information sequence in which normal traffic and anormal behavior traffic are labeled.

Here, the packet header information sequence may be generated to correspond to the maximum size represented by single field information of the packet header for each protocol, and may be generated to be separated into respective pieces of configuration information in the packet header.

Here, a portion that is not filled with data in the packet header information sequence may be padded with an arbitrary value (Ex. zero-padding or null values).

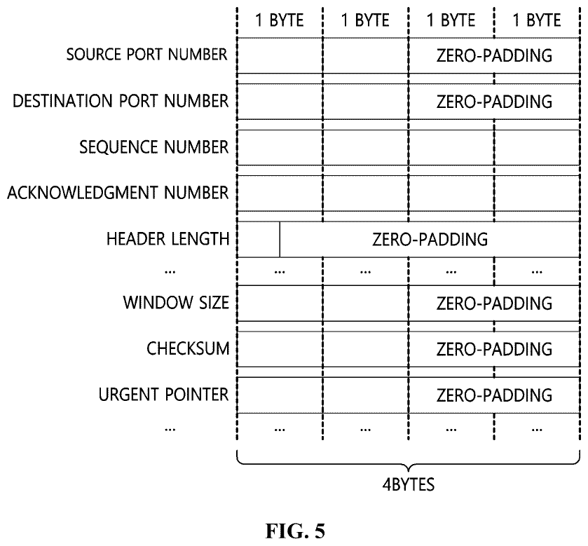

Hereinafter, an embedding process for utilizing packet header information in encrypted traffic as training data by taking a Transmission Control Protocol (TCP) as an example will be described in detail with reference to FIG. 5.

In conventional technology, protocol header information was arbitrarily fixed at a size of 2 bytes or 4 bytes, and was used to train and infer a network traffic classification model. Here, because bytes corresponding to the fixed size are used, there is a strong possibility that the header information of a specific protocol will be lost. For example, of the header information of the TCP protocol, a sequence number is information represented by 4 bytes, but it may be divided into 2 bytes and separately used so that the sequence number is input to the network traffic classification model. In another example, of the header information of the TCP protocol, ‘window size’ is information represented by 2 bytes, but even an offset field or TCP flag information is included and used in one piece of input data when data is input in units of 3 bytes or 4 bytes to the network traffic classification model. Therefore, according to the conventional technology, unique characteristics or discrimination of the field information in the protocol header, or the loss or alteration of values in the field information may inevitably occur.

Therefore, the present disclosure may generate the packet header information sequence by setting the maximum size represented by single field information of the protocol header to the size of data to be input to a network traffic classification model, thus generating a sequence without losing unique header information.

For example, referring to FIG. 5, the maximum size represented by single field information in the TCP protocol header is 4 bytes corresponding to the sequence number or acknowledgment number, and thus 4 bytes may be set to the sequence size. That is, the size of embedded data is fixed at a size of 4 bytes, but the embedded data is divided for each piece of unique information of the header, and thus the sequence may be generated.

In this case, as shown in FIG. 5, the source port number of the TCP header has 2 bytes corresponding to 16 bits, and thus a portion of the remaining 2 bytes among embedded 4 bytes may be padded with an arbitrary value (Ex. zero-padding or null values). For example, the input data may be embedded by padding a portion of the remaining bytes with 0 using a typical padding method. Also, because the sequence number of the TCP header has 4 bytes, the sequence number may be embedded as it is, and may then be used as input data for training and inference.

That is, according to the present disclosure, pieces of header information in TCP, in TCP and IP, or in User Datagram Protocol (UDP) and IP are neither combined with other pieces of protocol information nor divided into pieces of information, thus enabling a sequence to be generated without losing unique header information.

Here, the above-described packet header information embedding process in the TCP protocol is only an embodiment, and may also be applied to encrypted network traffic. Furthermore, the packet header information embedding process may be applied to various protocols such as IP, TCP, User Datagram Protocol (UDP), and Internet Control Message Protocol (ICMP), and may also be applied to a combination of IP and TCP, a combination of IP and UDP, etc. so as to generate a sequence if necessary.

Furthermore, in order to classify or infer network traffic for each encrypted traffic type, the present disclosure may tokenize a packet header information sequence based on instruction code used in pre-training of a BERT language model, and may use the tokenized results as training data.

Here, the instruction code may include instruction codes capable of indexing the values of all header information appearing in the training data and may include instruction code related to special tokens for exception handling in token indexing when the header information of each packet is recognized as each individual token.

Here, the instruction code related to the special tokens may correspond to code indicating a space, code signifying an individual token, code representing token indexing not found in a dictionary, code indicating the start of a sequence, code denoting the separation between two sequences, and code indicating a padding token.

For example, as shown in FIG. 5, after training data is generated based on the header information for each packet, the header of each packet may be regarded as an individual token, and instruction code capable of indexing the values of all header information appearing in the entire training data may be obtained in advance.

Here, for training of the network traffic classification model and exception handling in token indexing, special tokens may be utilized. For example, “ ” indicating a space, ‘[MASK]’ signifying an individual token, ‘[UNK]’ representing token indexing that is not found in the dictionary, ‘[CLS]’ indicating the start of a sequence, ‘[September]’ denoting the separation between two sequences (packets), ‘[PAD]’ representing a padding token, etc. may be used as the special tokens.

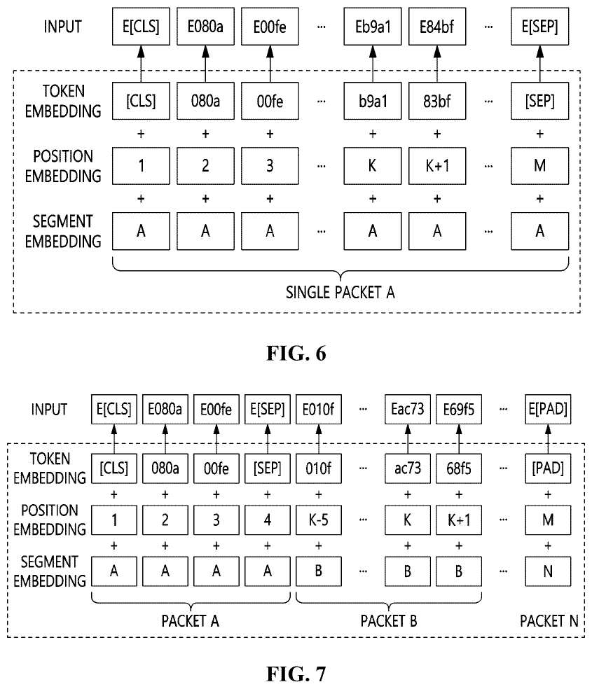

For example, FIG. 6 illustrates header information of a single packet among multiple TCP packets included in a flow, wherein a first token [CLS] of a packet header information sequence that is input to the BERT language model may correspond to a special token indicating the start of the sequence. Also, a special token [September] may be used to separate two connected sequences or indicate the end of the corresponding sequence.

Here, a combined vector may be used as the input of a bidirectional transformer by adding the results of position embedding and segment embedding to the result of the token embedding.

In this case, segment embedding may correspond to information for separating two packet header information sequences from each other when the two packet header information sequences are input.

Here, position embedding functions to perform the same function as positional embedding used in a transformer, and the present disclosure may use the position embedding to represent different positions of respective pieces of header information in the input packet header information sequences.

Such segment embedding and position embedding may be combined (merged) with token embedding indicating an embedding vector for each header information token, and then a single embedded value may be generated, after which the single embedded value may be used for training as the input vector of the BERT language model by applying a technique such as layer normalization or dropout.

Here, the training data may be generated by utilizing header information of a single packet or header information of multiple packets.

FIG. 7 illustrates the extension of the concept of the three types of token information input illustrated in FIG. 6, and shows an example in which pieces of multi-packet header information are embedded into the input sequence of a BERT language model based on the header information of multiple packets in a flow or session.

For example, a packet header information sequence is generated using 2 to N packets included in a flow by means of a collection mechanism defined in the system, wherein respective packets may be separated by special tokens [September]. By means of this configuration, normal activities and anormal activities in encrypted network traffic may be more effectively identified by performing training in consideration of not only association between packets but also correlation between generated tokens.

Further, in the method for detecting anormal behavior in encrypted network traffic using a BERT language model according to the embodiment of the present disclosure, the anormal behavior detection apparatus trains the network traffic classification model based on the BERT language model using the training data at step S130.

Here, the training data may be generated using the encrypted network traffic.

Here, the network traffic classification model according to the present disclosure corresponds to a model capable of performing binary classification on normal traffic and traffic including anormal behavior or malware in the encrypted network traffic using the packet header information.

Here, the network traffic classification model may correspond to a form in which an anormal behavior detection neural network layer for detecting anormal behavior in encrypted network traffic is added to a pre-trained BERT language model.

The network traffic classification model according to the present disclosure is based on the BERT model released by Google in 2018 and may utilize a pre-trained model. Such a BERT model is an encoder representation learning model implemented as a bidirectional transformer having a multi-layered structure.

Therefore, the present disclosure configures a packet header information sequence for each protocol as a sentence, and handles the header information of each packet as a token. Here, for pieces of packet header information configuring the sequence, a span of successive words is processed as one sentence regardless of components thereof.

In this case, Masked Language Model (MLM) training may be performed on the network traffic classification model using the packet header information sequence.

For example, referring to Equation (1), a packet header information sequence S may be composed of t₁, t₂, t₃, . . . , t₄ which are header information tokens of the packets.

$$S = {t}_{1} , {t}_{2} , {t}_{3} , … , {t}_{n} \qquad ( 1 )$$

Here, 15% of the packet header information sequence may be randomly selected, and may be changed to other tokens. For example, 80% of the selected tokens may be changed to masked tokens, 10% thereof may be changed to other tokens (e.g., corrupted tokens), and the remaining 10% may be maintained without change.

Here, the transformer encoder of the network traffic classification model according to the present disclosure may be trained to predict the masked tokens and the corrupted tokens.

For example, a Softmax layer located at a higher level of a transformer network may output the prediction probability of a specific token tn= [MASK], and the network traffic classification model may perform a procedure trained with a cross-entropy function.

Here, the above-described value such as 15% or 80% is only an example, and the present disclosure is not limited thereto.

In this case, Next Sentence Prediction (NSP) training may be performed on the network traffic classification model using the packet header information sequence.

Generally, because a language model is trained on a sentence basis, a problem arises in that it is difficult to learn a relationship between sentences.

In order to solve this problem, the present disclosure may use a NSP method upon training the network traffic classification model, and this process may be performed together with the MLM training, described above.

For example, as examples for NSP training, two packet header information sequences A and B may be extracted and used from the entire corpus stored in the system. Here, 50% of tokens may use actual consecutive sentences, and the remaining 50% thereof may use two random sentences. Thereafter, training may be performed in such a way as to perform binary classification of determining whether or not these sentences are next sentences using token named C, which is output last.

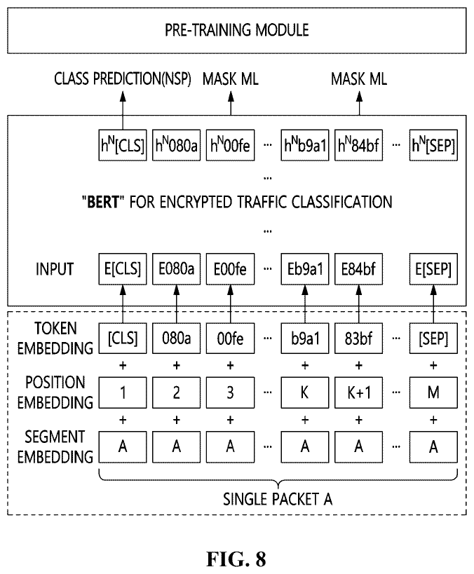

Hereinafter, a process of training a network traffic classification model will be described in detail with reference to FIG. 8.

First, the network traffic classification model may be generated by adding a neural network layer for detecting/classifying anormal behavior in encrypted network traffic based on a pre-trained BERT language model, and the training of the network traffic classification model may be performed using a packet header information sequence in which normal traffic and anormal behavior traffic are labeled.

Here, the detection of anormal behavior traffic may correspond to binary classification of classifying specific traffic into normal traffic and anormal behavior traffic. For this, the network traffic classification model may be composed of an input layer which receives the packet header information sequence, the BERT language model which is pre-trained with the packet header information sequence, a one-dimensional (1D) pooling layer, a fully connected layer having a rectified linear unit (ReLU) activation function, and a binary classification layer having a sigmoid activation function.

For example, the input layer may be have a size of 512 dimensions, the 1D layer may have a size of 256 dimensions, the fully connected layer may have a size of 128 dimensions, Adam may be used as an optimization method, and a binary cross entropy function may be designed and used as a loss function.

Thereafter, a packet header information sequence extracted from an anormal behavior packet may be labeled with ‘malicious’ (e.g., malware), and a packet header information sequence extracted from normal traffic may be labeled with ‘normal’, after which the labeled sequences may be used as a training dataset and a test dataset that are tokenized by a header information tokenizer.

In this way, after the network traffic classification model is configured, learning parameters of the pre-trained BERT language model are designated not to be learned, and the network traffic classification model may be executed to learn the learning parameters of the remaining layers other than the BERT language model by inputting the training dataset.

After training is completed, the network traffic classification model may be designated again to learn the learning parameters of the pre-trained BERT language model, after which the test dataset may be input to the trained network traffic classification model.

Here, a new malware detection neural network layer for detecting new malware that is not previously known is added to the network traffic classification model, and may be trained using a packet header information sequence.

Here, the packet header information sequence may be tokenized based on the instruction code used for pre-training of the BERT language model, and the tokenized packet header information sequence may be input to the network traffic classification model to perform training to detect new malware that is previously unknown.

Furthermore, in the method for detecting anormal behavior in encrypted network traffic using a BERT language model according to the embodiment of the present disclosure, the anormal behavior detection apparatus classifies anormal behavior traffic in encrypted network traffic based on the trained network traffic classification model at step S140.

In an example, the network traffic classification model according to the embodiment of the present disclosure may perform binary classification as to whether the corresponding traffic is normal traffic or anormal behavior traffic by receiving one packet header information sequence as input.

In another example, the network traffic classification model according to the embodiment of the present disclosure may perform binary classification or multi-classification for each application by receiving multiple types of traffic included in one flow as input.

In a further example, the network traffic classification model according to the embodiment of the present disclosure may be designed for each task such as detection of new malware that is previously unknown, and may perform pre-training and fine-tuning, thus detecting a new type of malware in encrypted traffic.

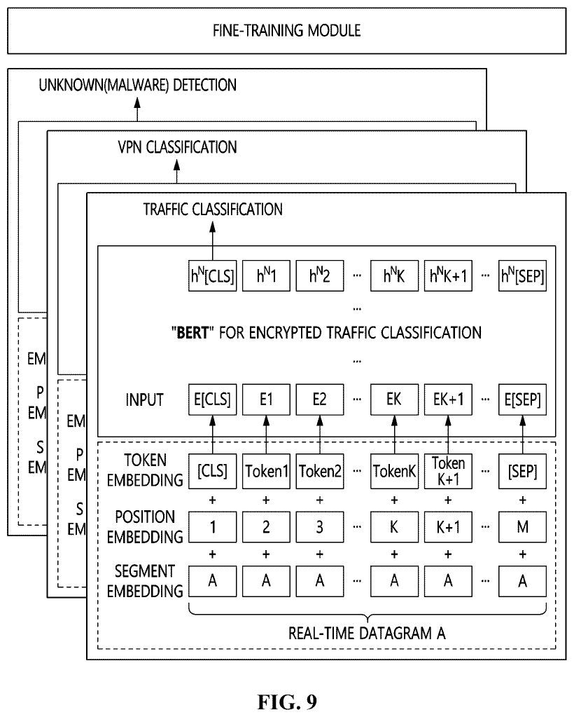

That is, referring to FIG. 9, a layer for new (previously unknown) malware detection is added onto the BERT language model, and a task capable of executing the layer may be performed.

Referring to FIG. 9, the process of detecting previously unknown malware according to the embodiment of the present disclosure may collect packets corresponding to unknown encrypted network traffic, may generate a sequence of pieces of header information of the collected packets, and may tokenize the sequence of header information using instruction code used for pre-training of the BERT language model. Thereafter, whether the corresponding traffic is normal traffic or anormal behavior traffic including malware may be determined by inputting the tokenized packet header information sequence to the network traffic classification model that has been trained.

By means of the method for detecting anormal behavior in encrypted network traffic using the BERT language model, network traffic or encrypted network traffic for each traffic type may be classified based on BERT represented by a language model among AI technologies, and anormal behavior in the classified traffic may be detected.

Further, the present disclosure may improve the accuracy of detection of anormal behavior and malware in encrypted traffic by performing pre-training and fine-tuning on a classification model through a pattern in which unique information of a packet header for each protocol is represented and embedded without loss.

Furthermore, the field information of packet headers may be variably extracted for various respective communication protocols, and may be embedded in each sequence.

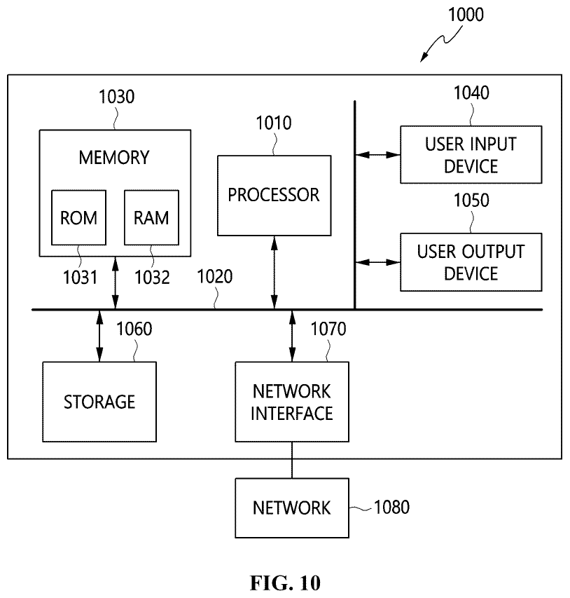

FIG. 10 is a diagram illustrating an apparatus for detecting anormal behavior in encrypted network traffic using a BERT language model according to an embodiment of the present disclosure.

Referring to FIG. 10, the apparatus for detecting anormal behavior in encrypted network traffic using a BERT language model according to the embodiment of the present disclosure may be implemented in a computer-readable storage medium. As illustrated in FIG. 10, a computer system 1000 may include one or more processors 1010, memory 1030, a user input device 1040, a user output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing processing instructions stored in the memory 1030 or the storage 1060. Each of the memory 1030 and the storage 1060 may be any of various types of volatile or nonvolatile storage media. For example, the memory 1030 may include Read-Only Memory (ROM) 1031 or Random Access Memory (RAM) 1032.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

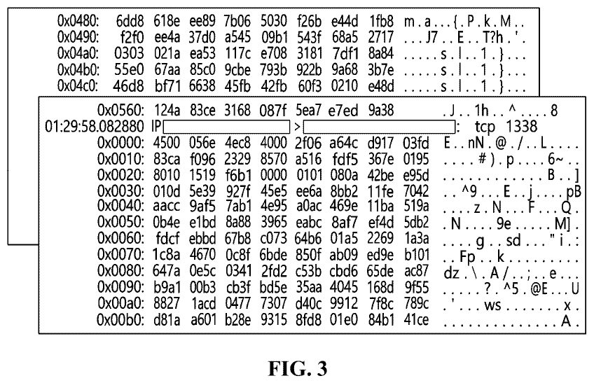

Here, the apparatus for detecting anormal behavior according to an embodiment of the present disclosure may be configured in the form of an encrypted traffic packet collection module 210, a packet header information sequence embedding module 220, a pre-training module 230, and an anomaly detection and classification module 240, as illustrated in FIG. 2.

Hereinafter, for convenience of description, an anormal behavior detection process will be described based on one processor 1010 which performs the operations of respective modules illustrated in FIG. 2.

The processor 1010 collects encrypted network traffic from the network.

Further, the processor 1010 generates training data in which header information for each packet is preprocessed in the format of a sequence based on the encrypted network traffic.

Here, the training data may correspond to a packet header information sequence in which normal traffic and anormal behavior traffic are labeled.

Here, the packet header information sequence may be generated to correspond to the maximum size represented by single field information of the packet header for each protocol, and may be generated to be separated into respective pieces of configuration information in the packet header.

Here, a portion that is not filled with data in the packet header information sequence may be padded with an arbitrary value (Ex. zero-padding or null values).

The packet header information sequence may be tokenized based on instruction code used in pre-training of the BERT language model, and the tokenized results may be used as training data.

Here, the instruction code may include instruction codes capable of indexing the values of all header information appearing in the training data and may include instruction code related to special tokens for exception handling in token indexing when the header information of each packet is recognized as each individual token.

Here, the instruction code related to the special tokens may correspond to code indicating a space, code signifying an individual token, code representing token indexing not found in a dictionary, code indicating the start of a sequence, code denoting the separation between two sequences, and code indicating a padding token.

Here, the training data may be generated by utilizing header information of a single packet or header information of multiple packets.

Further, the processor 1010 trains a network traffic classification model based on the BERT language model using the training data.

Here, the network traffic classification model may correspond to a form in which an anormal behavior detection neural network layer for detecting anormal behavior in encrypted network traffic is added to a pre-trained BERT language model.

In this case, Masked Language Model (MLM) training may be performed on the network traffic classification model using the packet header information sequence.

In this case, Next Sentence Prediction (NSP) training may be performed on the network traffic classification model using the packet header information sequence.

Here, a new malware detection neural network layer for detecting new malware that is not previously known is added to the network traffic classification model, and may be trained using a packet header information sequence.

Here, the packet header information sequence may be tokenized based on the instruction code used for pre-training of the BERT language model, and the tokenized packet header information sequence may be input to the network traffic classification model to perform training to detect new malware that is previously unknown.

Furthermore, the processor 1010 classifies anormal behavior traffic in the encrypted network traffic based on the trained network traffic classification model.

The memory 1030 stores the trained network traffic classification model.

Further, the memory 1030 stores various types of information generated by the apparatus for detecting anormal behavior in encrypted network traffic using a BERT language model according to the embodiment of the present disclosure.

According to an embodiment, the memory 1030 may be configured independently of the apparatus for detecting anormal behavior in encrypted network traffic using the BERT language model, and may support a function of detecting anormal behavior in encrypted network traffic using the BERT language model. Here, the memory 1030 may function as separate mass storage, and may include a control function for performing operations.

Meanwhile, the apparatus for detecting anormal behavior in encrypted network traffic using a BERT language model may be equipped with memory to store information therein. In an embodiment, the memory may be a computer-readable medium. In an embodiment, the memory may be a volatile memory unit, and in another embodiment, the memory may be a nonvolatile memory unit. In an embodiment, a storage device may be a computer-readable medium. In various different embodiments, the storage device may be, for example, a hard disk device, an optical disk device, or another type of mass storage device.

By using the apparatus for detecting anormal behavior in encrypted network traffic using a BERT language model, network traffic or encrypted network traffic may be classified for respective types based on BERT represented by a language model, among AI technologies, and anormal behavior in the traffic may be detected.

Further, the accuracy of purpose-wise classification or detection of anormal behavior and malware in encrypted traffic may be improved by performing pre-training and fine-tuning on a classification model through a pattern in which unique information of a packet header for each protocol is represented and embedded without loss.

According to the present disclosure, network traffic or encrypted network traffic may be classified for respective types and anormal behavior may be detected, based on BERT represented by a language model among AI technologies.

Further, the present disclosure may improve the accuracy of detection of anormal behavior and malware in encrypted traffic by performing pre-training and fine-tuning on a classification model through a pattern in which unique information of a packet header for each protocol is represented and embedded without loss.

As described above, in the method for detecting anormal behavior in encrypted network traffic using a BERT language model and the apparatus for the method according to the present disclosure, the configurations and schemes in the above-described embodiments are not limitedly applied, and some or all of the above embodiments can be selectively combined and configured so that various modifications are possible.

What is claimed is:

1. A method for detecting anormal behavior in encrypted network traffic, the method being performed by an anormal behavior detection apparatus, the method comprising:
collecting encrypted network traffic from a network;
generating training data in which header information for each packet is preprocessed in a format of a sequence, based on the encrypted network traffic;
training a network traffic classification model based on a Bidirectional Encoder Representations from Transformers (BERT) language model using the training data; and
classifying anormal behavior traffic in encrypted network traffic based on the trained network traffic classification model.

2. The method of claim 1, wherein the training data corresponds to a packet header information sequence in which normal traffic and anormal behavior traffic are labeled.

3. The method of claim 2, wherein the packet header information sequence is generated to correspond to a maximum size represented by single field information of a packet header for each protocol, and is generated such that respective pieces of configuration information are separated from each other in the packet header.

4. The method of claim 3, wherein a portion that is not filled with data in the packet header information sequence is padded with an arbitrary value.

5. The method of claim 1, wherein the network traffic classification model corresponds to a form in which an anormal behavior detection neural network layer for detecting anormal behavior in the encrypted network traffic is added to a pre-trained BERT language model.

6. The method of claim 2, wherein training the network traffic classification model comprises:
performing Masked Language Model (MLM) training on the network traffic classification model using the packet header information sequence; and
performing Next Sentence Prediction (NSP) training on the network traffic classification model using the packet header information sequence.

7. The method of claim 5, wherein training the network traffic classification model comprises:
adding a new malware detection neural network layer for detecting new malware that is previously unknown to the network traffic classification model, and training the new malware detection neural network layer using the packet header information sequence.

8. The method of claim 7, wherein training the new malware detection neural network layer comprises:
tokenizing the packet header information sequence based on an instruction code used for pre-training of the BERT language model, and training the network traffic classification model to detect new malware that is previously unknown by inputting a tokenized packet header information sequence to the network traffic classification model.

9. The method of claim 8, wherein the instruction code includes instruction codes capable of indexing values of all header information appearing in the training data, and includes instruction codes related to special tokens for exception handling in token indexing when header information of each packet is recognized as an individual token.

10. The method of claim 9, wherein the instruction codes related to the special tokens correspond to a code indicating a space, a code signifying an individual token, a code representing token indexing not found in a dictionary, a code indicating start of a sequence, a code indicating separation between two sequences, and a code indicating a padding token.

11. The method of claim 1, wherein the training data is generated by utilizing header information of a single packet or pieces of header information of multiple packets.

12. An anormal behavior detection apparatus, comprising:
a processor configured to collect encrypted network traffic from a network, generate training data in which header information for each packet is preprocessed in a format of a sequence, based on the encrypted network traffic, train a network traffic classification model based on a Bidirectional Encoder Representations from Transformers (BERT) language model using the training data, and classify anormal behavior traffic in encrypted network traffic based on the trained network traffic classification model; and
a memory configured to store the network traffic classification model.

13. The anormal behavior detection apparatus of claim 12, wherein the training data corresponds to a packet header information sequence in which normal traffic and anormal behavior traffic are labeled.

14. The anormal behavior detection apparatus of claim 13, wherein the packet header information sequence is generated to correspond to a maximum size represented by single field information of a packet header for each protocol, and is generated such that respective pieces of configuration information are separated from each other in the packet header.

15. The anormal behavior detection apparatus of claim 14, wherein a portion that is not filled with data in the packet header information sequence is padded with an arbitrary value.

16. The anormal behavior detection apparatus of claim 12, wherein the network traffic classification model corresponds to a form in which an anormal behavior detection neural network layer for detecting anormal behavior in the encrypted network traffic is added to a pre-trained BERT language model.

17. The anormal behavior detection apparatus of claim 13, wherein the processor is configured to perform Masked Language Model (MLM) training on the network traffic classification model using the packet header information sequence, and perform Next Sentence Prediction (NSP) training on the network traffic classification model using the packet header information sequence.

18. The anormal behavior detection apparatus of claim 16, wherein the processor is configured to add a new malware detection neural network layer for detecting new malware that is previously unknown to the network traffic classification model, and train the new malware detection neural network layer using the packet header information sequence.

19. The anormal behavior detection apparatus of claim 18, wherein the processor is configured to tokenize the packet header information sequence based on an instruction code used for pre-training of the BERT language model, and train the network traffic classification model to detect new malware that is previously unknown by inputting a tokenized packet header information sequence to the network traffic classification model.

20. The anormal behavior detection apparatus of claim 19, wherein the instruction code includes instruction codes capable of indexing values of all header information appearing in the training data, and includes instruction codes related to special tokens for exception handling in token indexing when header information of each packet is recognized as an individual token.
